(19) United States
(12) Patent Application Publication
(10) Pub. No.: US 2014/0106038 A1
(43) Pub. Date: Apr. 17, 2014

(54) Apparatus and related methods of roasting, grinding, and brewing coffee

(71) Applicant: Kenneth Buschmann, St. Augustine, FL (US)

(72) Inventor: Kenneth Buschmann, St. Augustine, FL (US)

(21) Appl. No.: 14/032,161

(22) Filed: Sep. 19, 2013

Related U.S. Application Data
(60) Provisional application No. 61/702,988, filed on Sep. 19, 2012.

(51) Int. Cl. A23F 5/04

(52) U.S. Cl. CPC A23F 5/04
USPC 426/296

(57) ABSTRACT

Disclosed are apparatus and related methods of roasting coffee beans, grinding coffee beans and brewing ground coffee. The purpose of this disclosure is to provide a more flavorful coffee brew while minimizing bitterness, acidity, astringency and sourness. The disclosed apparatus and related methods demonstrate economic benefits (e.g., cost savings) over the prior art. In the coffee bean roasting methodologies, caffeol oils (the essence of coffee flavor) are captured via diatomaceous earth or similarly porous powders. Additional chemicals may be added to the coffee beans to enhance overall bean flavor. After roasting the beans are ground. Finally, the ground coffee is brewed with activated carbon to remove undesirable chemicals that cause bitterness, acidity, astringency, and/or sourness.

### CROSS-REFERENCE TO RELATED APPLICATIONS

This application claims the benefit and priority of U.S. Prov. Pat. Ser. No. 61/702,988 (filed Sep. 19, 2012) and that document is hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR COMPUTER PROGRAM LISTING APPENDIX SUBMITTED ON A COMPACT DISC

Not applicable.

### BACKGROUND OF THE INVENTION

1. Field of Invention

The disclosed subject matter is in the field of apparatus and related methods of roasting coffee beans, grinding coffee beans, and brewing ground coffee. The disclosed subject matter is also in the field of improved and possibly cost saving coffee preparation by capturing the essential flavor oils, introducing beneficial chemicals to the roasting process (e.g., producing chemicals during the roasting process), minimizing grind size during coffee grinding, and removing unwanted chemicals from the coffee grinds during brewing.

2. Background of the Invention

Coffee is a popular brewed beverage prepared from the grinds of roasted coffee beans (i.e., roasted seeds of coffee berries). Prior to roasting, coffee beans are: (1) harvested from coffee berries via removal of the berries pulp; (2) dried (e.g., sun dried or dried with a dryer); and (3) milled (i.e., sorted by size, density, and color). Once dried and milled, the beans may be roasted, wherein heat from the roasting process causes the beans to expand and change color, aroma, taste, and density. Roasted beans may be ground and brewed to provide a coffee beverage.

The roasting profile (i.e., the pathway of time and temperature taken by the bean during roasting) employed for roasting a batch of coffee beans will typically affect the intrinsic flavors, or “cultivar,” of any coffee beverage brewed from said batch (cultivar is a term that describes the intrinsic flavors that are present in an unroasted coffee bean). One reason that coffee cultivar is affected by the roasting profile is that aromatic oils and other flavorful chemicals are produced and/or depleted by exposure to heat over time. For instance, (a) most coffee beans are roasted at temperatures between three-hundred and seventy and four-hundred and eighty degrees Fahrenheit; (b) caffeol oil, the essence of coffee flavor that is produced in the beans during roasting, begins to bleed to the surface of the bean at to temperatures of around four-hundred degrees Fahrenheit; and (c) caffeol oil on the surface of a coffee bean can vaporize or burn off when exposed to heat. For another instance, sugars within the coffee bean begin to caramelize at temperatures between three hundred and twenty and three hundred and fifty-six degrees Fahrenheit. Another reason that coffee taste is affected by the roasting profile is that heat from the roasting process can produce or break down (degrade) chemicals that are distasteful. Accordingly, a need exists for apparatus and related methods of roasting coffee beans and/or preparing brewed coffee wherein flavorful oils are captured while the amounts of distasteful chemicals in the coffee bean are reduced.

Roasted and/or ground bean shelf-life can also affect coffee cultivar because aromatic oils can slowly be emitted and vaporized on the roasted bean surface at room temperature. For instance caffeol oil, which is volatile and oxidizes easily, is emitted from a roasted bean surface and outgassed for several days after roasting. For the same reason, ground coffee beans slowly lose caffeol oils. Accordingly, there is a need for apparatus and related methods of preserving coffee cultivar by minimizing oils lost after the bean has been roasted, during grinding, and before brewing.

Coffee grinding has also been known to affect coffee cultivar. For instance as grind size is reduced, more chemicals, whether delicious or distasteful, are release into the water than larger grinds brewed for the same amount of time. This means that smaller grinds are preferred to larger grinds since, a smaller amount of finely ground coffee can impart the same flavors to a coffee brew as a larger amount of course ground coffee. However, fine coffee grinds are known to result in a bitter cup of coffee when brewed according to the customary manner. Thus, a need exists for brewing finely ground coffee so that coffee is conserved and flavor is imparted.

### SUMMARY OF THE DISCLOSED EMBODIMENT

In view of the foregoing, it is an object of the present disclosure to describe apparatus and related methods of roasting coffee beans and/or preparing brewed coffee wherein: flavorful oils are captured while the amounts of distasteful chemicals in the coffee bean are reduced; the loss of flavorful oils is minimized after roasting and/or grinding of a coffee bean; and, so that finely ground coffee can be brewed. Suitably, the disclosed methodologies comprise mixing activated carbon and diatomaceous earth (hereinafter “DE”) with coffee beans or grinds during the roasting, grinding, and/or brewing process. Suitably, the DE may absorb and insulate any icy essential oils produced during the roasting process to prevent burn-off. Also, activated carbon (whether added during roasting or brewing) may remove distasteful chemicals produced during the roasting process.

In one embodiment, the disclosed method involves the steps of: (1) roasting a batch of coffee beans; and (2) either bonding DE to the surface of the coffee bean or providing DE to the subsurface of the coffee bean. In one embodiment, bonding of the DE to the bean surface may be accomplished via adding a mixture of DE and water or sugar (e.g., reducing sugar or sucrose) to the batch when the same has reached a temperature of two-hundred and seventy five degrees Fahrenheit or above. Suitably, when said mixture is added to the batch at said temperatures, the sugar may be caramelized and, as a result, bond DE to the surface of the coffee bean. Preferably, the specific timing of the addition of the DE and water or sugar mixture to the batch will depend on the oils to be absorbed. Suitably, providing DE to the subsurface of a coffee bean may be accomplished via (i) soaking raw or green coffee beans in a water and sugar (e.g., reducing sugar or sucrose) solution for approximately an hour at a temperature of one-hundred and fifty degrees Fahrenheit, (ii) mixing the soaked beans with DE powder so that the surfaces of the beans are coated with DE, and (iii) drying the beans (e.g., using an air dryer) at a temperature of two-hundred degrees Fahrenheit. In one embodiment, providing DE to the subsurface of the bean and bonding DE to the surface of the bean may both be incorporated into a single roasting methodology.

Suitably, Activated carbon may be added throughout the roasting process to remove any distasteful chemicals emitted as a byproduct of the roasting process. Preferably, additional DE may be added via coating the roasted beans with additional coats of caramelized DE and sugar. In a further embodiment, the disclosed method involves the steps of: (1) grinding a batch of roasted coffee beans into grinds; (2) adding activated carbon to the grinds; and (3) brewing the grinds with the activated carbon into coffee.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a top view of a single-brew coffee grind container; and,

FIG. 2 is a cross section of the single-brew coffee grind container.

It is to be noted, however, that the appended figures illustrate only a typical embodiment of the disclosed apparatus and are therefore not to be considered limiting of its scope, for the disclosed apparatus may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Generally, disclosed are apparatus and related methodologies comprise mixing activated carbon and diatomaceous earth (“DE”) with coffee beans or grinds during to the roasting, grinding, and/or brewing process. Suitably, the DE may absorb and preserve any essential oils produced during the roasting process while the activated carbon (whether added during roasting or brewing) may remove distasteful chemicals produced during the roasting process. The specifics of the process and related apparatus are disclosed below.

1. Roasting Process

In one embodiment, coffee beans may be roasted so that flavorful oils are retained and so that distasteful chemicals are minimized in the roasted bean. First, a plurality of raw or green coffee beans may be acquired. The bean may suitably be seeds from any evergreen shrub of the genus Coffea. That said, in a preferred embodiment the coffee beans are acquired from Arabica or Robusta coffee plants (i.e. Arabica or Robusta seeds). Those of skill in the art will know well the sources of such seeds. In a preferred embodiment, raw or green beans may be purchased from numerous suppliers, including local roasters such as Jayell's Coffee Company of St. Augustine, Fla., U.S.A. (http://jayellscoffee.com/)

Second, the plurality of raw coffee beans may be placed in a roaster. Suitably, the roaster may be defined by ordinary kitchen equipment (e.g., frying pans, grills, ovens or popcorn poppers), specialized appliance (e.g., drum roasters or fluidized bed roasters), or any other item capable of heating the beans to temperatures between three hundred and seventy and four-hundred and eighty degrees Fahrenheit. In a one embodiment, the roaster may be a West Bend®, 82416—Air Crazy Hot Air Popcorn Popper (http://westbend.com/air-crazy-hot-air-popcorn-popper.html). In a preferred embodiment, the roaster may be a commercial drum or fluidized bed roaster. Those of ski in the art will know well the types and batch amounts of coffee beans capable of being roasted in any particular roaster.

Third, the type of roast to be accomplished may be selected. Generally, the type of roast falls within a spectrum of four categories, namely: Light; Medium; Dark, and Darkest. Light roasted beans produce a flavor that is light-bodied and sour, grassy, and snappy. Medium roasted beans produce a flavor that is sweeter than a light roast, full bodied balanced by an acidic snap, aromatic and complex. Dark roasted beans produce a flavor that is rich-chocolaty bodied and aromatic instead of sweet. Finally, Darkest roasted beans produce a flavor that is smokey. Those of skill in the art will know well the coffee roast types.

Fourth, the plurality of coffee beans may suitably be roasted using the roaster. However, during or prior to roasting, DE is preferably bonded to the surface of the bean or provided to the subsurface of the coffee bean. In one embodiment, providing DE to the surface or subsurface of a coffee bean may be accomplished via (i) soaking raw or green coffee beans in a water and sugar (e.g., reducing sugar or sucrose) solution for approximately an hour at a temperature of one-hundred and fifty degrees Fahrenheit, (ii) mixing the soaked beans with DE powder so that the surfaces of the beans are coated with DE, and (iii) drying the beans (e.g., using an air dryer) at a temperature of two-hundred degrees Fahrenheit. Suitably, the water and sugar solution may include sugar at five percent of the weight of the green coffee beans being soaked. In one embodiment, the two thirds cup of green beans were soaked in two hundred cubic centimeters of water with sugar at five percent the weight of the beans. In an optional embodiment, enzymes may be added to the water and sugar soaking solution so that long-chain proteins inside of the coffee beans may be broken down prior to roasting. For example, a papain enzyme from papaya, Citric acid, or Ma ic acid may be mixed with the solution. Preferably, the soaked and coated beans may be dried with an air dryer or, in a preferred embodiment, tumble dried to maintain the DE coating.

For a light roast, the green coffee beans may be roasted for seven minutes to a bean core temperature of between four-hundred and fifteen to four-hundred and twenty-five degrees Fahrenheit. Suitably, the light roasted beans, will have “popped” or cracked since the beans will have almost doubled in size. For a medium roast, coffee beans may be roasted for nine to eleven minutes to a bean core temperature of between four-hundred and twenty-five to four-hundred and forty-five degrees Fahrenheit. For a dark roast, coffee beans may be roasted for twelve to thirteen minutes to a bean core temperature of between four-hundred and forty-five to four-hundred and seventy degrees Fahrenheit. Suitably, the dark roasted beans hiss and pop again while of rises to the surface. For a darkest roast, coffee beans may be roasted for fourteen or more minutes to a bean core temperature of between four-hundred and seventy to four-hundred and eighty-five degrees Fahrenheit. Visually, the darkest roasted beans are caramelized and begin to smoke as the sugars carbonize.

In another embodiment, DE powder may be mixed with the beans during roasting. Suitably, any amount of DE may be mixed with the beans, but, in a preferred embodiment, DE is added to the beans at five to ten percent of the weight of the green coffee beans provided to the roaster. Optionally, sugar (confectionary sugar) may also be added at the same is weight percentages as the DE. Suitably, the DE and the sugar may be mixed with water and sprayed on the beans, in an even coat, during roasting. IT should be noted that the DE may be applied to the beans by atomization or by dusting. Preferably, DE and water or sugar may be provided to the batch of roasting beans anytime the same has reached a temperature of two hundred and seventy five degrees Fahrenheit or above. Suitably, the DE and water or sugar may be added in a single dose or multiple doses. Suitably, a coating of DE should be visible to the eye on the outside of the coffee beans. Suitably, the DE and water or sugar solution may be provided to the beans during any type of roast described above (e.g., light, medium, dark, or darkest).

In one embodiment, providing DE to the subsurface of the bean and bonding DE to the surface of the bean may both be incorporated into a single roasting methodology. In this embodiment, the green beans may be (1) soaked in water and sugar, coated with DE, and dried, and (2) roasted with the addition of DE powder, or DE in a sugar or water solution as described above.

### Bean Roasting Examples

### Example 1

Beans have been roasted according to the above disclosure. Two grades of green coffee beans were acquired: (1) Nicaragua Arabica (TYPE 1); and (2) Carvaci' Auto Bahn Smoothe Ride Espresso Arabica (TYPE 2). Both grades of beans were purchased from Jayell's Coffee Company of St Augustine Fla. Two, one-third cups of beans were roasted separately (so that the beans could maintain a fluidized flow) in an Air Crazy Popcorn Popper and then combined in a single batch. Each type of bean was roasted into six batches (twelve total): batches of each bean at two core temperatures and three applications of DE. Specifically, Each bean batch was roasted to a core temperature of four-hundred and ten (TEMP 1) and four-hundred and forty-five (TEMP 2) degrees Fahrenheit with the following applications of DE: (1) powdered DE at five percent the weight of the green beans in the batch (APP 1); (2) a solution of one hundred cubic centimeters of water with DE and sugar, wherein the DE and sugar components were each at five percent the weight of the green beans in the batch (APP 2); and (3) a solution of one hundred cubic centimeters of water with DE and sugar, wherein the DE and sugar components were each at ten percent the weight of the green beans in the batch (APP 3). DE amounts were added at temperatures between three hundred and thirty eight and three-hundred and ninety-two degrees Fahrenheit. Temperatures were measured using a digital probe. Four base line batches (i.e., without DE (APP 0)) were made, namely a batch each type of bean at each temperature. The base line batches were visually compared to the twelve other batches. The batches were then brewed in the customary manner and taste tested.

TYPE 1 & 2, TEMP 1 APP 0

Roast results—bean surface was dry, no oily appearance.
Brew Results—Nominal flavor, including minimal bitterness.

TYPE 1 & 2, TEMP 2, APP 0

Roast results—Oil droplets present on the bean surface; oily sheen.
Brew Results—coffee flavor and aroma with a mild after taste.

TYPE 1 & 2 TEMP 1, APP 0 v. Type 1 & 2, TEMP 1, APP 1

Roast results—Minimal DE coating on surface—no oil adhesion.
Brew Results—No difference from the baseline.

TYPE 1 & 2, TEMP 1, APP 0 v Type 1 & 2 TEMP 1 APP 2

Roast results—DE coating noticeable due to carmelization of the confectionary sugar; oil absorbed in the caramelized sugar with DE.
Brew Results—improved coffee flavor and semi-sweet.

TYPE 1 & 2, TEMP 1, APP 0 v Type 1 & 2, TEMP 1, APP 3

Roast results—DE coating very prevalent due to carmelization of the confectionary sugar; oil absorbed in the caramelized sugar with DE.
Brew Results—improved coffee flavor and semi-sweet.

TYPE 1 & 2, TEMP 2, APP 0 v Type 1 & 2, TEMP 2, APP 1

Roast results—very apparent coating of DE on the surface of the beans—oil droplets absorbed into the DE-coating estimated at ten percent of the bean surface.
Brew Results—More coffee flavor than the baseline.

TYPE 1 & 2, TEMP 2, APP 0 v Type 1 & 2, TEMP 2, APP 2

Roast results—very apparent coating of DE on the surface of the beans—caramelized appearance with oil droplets absorbed into the DE and sugar-coating estimated at fifty percent of the bean surface.
Brew Results More coffee flavor than the baseline and semi-sweet.

TYPE 1 & 2, TEMP 2, APP 0 v Type 1 & 2, TEMP 2, APP 3

Roast results—very apparent coating of DE on the surface of the beans caramelized appearance with oil droplets absorbed into the DE and sugar-coating estimated at eighty percent of the bean surface. Oil appears caked into the DE and sugar coating.
Brew Results—More coffee flavor and aroma than the baseline and semi-sweet.

### Example 2

The beans in Example 2 were roasted in accordance with the protocols of Example 1 except DE and sugar was mixed with two-hundred cubic centimeters of water instead of one hundred cubic centimeters and the mixture was added at bean core temperatures of two hundred and seventy five degrees instead of three hundred and thirty eight or ninety two degrees Fahrenheit.

Roast results—very thick coating on surface—Oil was absorbed and caked into the DE mixture with an estimated one hundred percent of the surface coated.
Brew Results—Coffee flavor and aroma dramatically improved and the semi-sweetness very strong.

2. Grinding

Suitably roasted coffee beans may be ground according to known methods. For instance, coffee beans may be ground with a burr, mill, or blade grinder to a fine or small grind. DE powder may be mixed with the to grind to absorb any coffeol oils that might be released. It should be noted, as described above in the background section, that a smaller amount of a fine coffee grind can produce coffee at the same strength as a larger amount of a course coffee grind. This fact can result in an economic advantage at the cost of bitterness in the coffee flavor. Thus, activated carbon, twenty by fifty (20×50) mesh size with an iodine number of 1100, may be mixed with the grind to reduce bitterness via absorption of distasteful or bitter chemicals. In one embodiment, each 8 ounce brew can be produced by two table spoons of grinds and one-half teaspoon of activated carbon. In a preferred embodiment, the grinds may suitably be mixed with activated carbon (with an iodine number of 800 to 1100) at five to seven percent by weight of the coffee grinds so that distasteful chemicals can be removed during brewing.

3. Brewing

Suitably, coffee grinds prepared according to this disclosure can be brewed according to any known brewing method, including but not limited to: boiling, steeping, drip brewing, or pressurized percolation. Those of skill in the art will know well the methods for brewing. Other Known methods of brewing include beverage filter cartridge. See, e.g., U.S. Pat. Nos. 5,325,765 and 5,840,189. This application discloses an improved beverage filter cartridge for brewing.

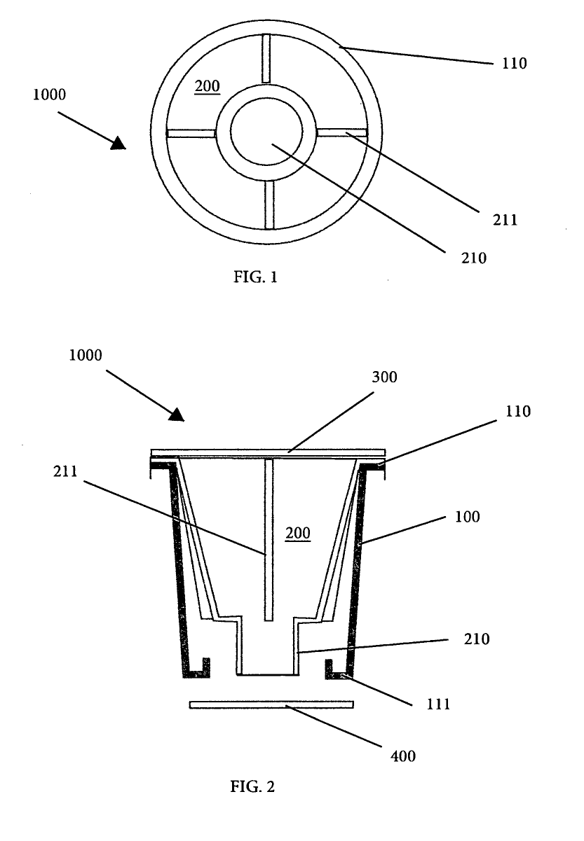

FIG. 1 is a top view of a beverage filter cup 1000. FIG. 2 is a cross section of the beverage filter cup 1000 of FIG. 1. As shown the cup is defined by: a brewing container 100 with a top lip 110 and a bottom lip 111; a molded porous filter cup 200 that is coupled to the lip of the brewing container 100 so that its body tapers downwardly to a permeable support extension chamber 210; and upper foil seal 300 that is adhered to the top lip 110 of the brewing container 100; and a lower foil seal 400 that is adhered to the bottom lip 111. In a preferred embodiment, the filter cup 200 is defined by a molded, porous plastic filter. As shown, the filter cup tapers away from the sidewalls of the brewing container 100 toward its center and a support extension chamber (permeable) that provides support to the bottom of the lower seal 400. Additionally, the support extension chamber 210 has an inlet area of a bout five percent of the filter cup 200, and, as a result, may be filled with powdered cream while the remainder of the filter cup 200 is filled with coffee grinds described above. For additional support for the filter cup 200 the walls of the filter cup 200 may be provided with ribs 211. Suitably, the bottom lip 111 is defined by a radial reinforcing double bend so that a wider and stronger surface is available for adherence to the lower foil seal 400. In a preferred embodiment, the lower and upper foil seals 300,400 are piercable and the dimensions of the brewing container configured so that the same may operate the manner disclosed by U.S. Pat. Nos. 5,325,765 and 5,840,189. In other words. In use, the filter cup may be filled with coffee, the seal's pierced, and water flushed through the upper to the lower seal piercings. In an embodiment capable of producing a cappuccino, the support extension chamber is filled with powdered cream.

Although specific features of the invention are shown in some drawings and not others, this is for convenience only as some feature may be combined with any or all of the other features in accordance with the invention. Other embodiments will occur to those skilled in the art and are within the following claims.

I claim:

1. A method of roasting a coffee bean comprising the steps of:
bonding DE to the surface of the coffee bean; and,
roasting the bean.

2. The method of claim 1 wherein the bonding of the DE to the bean surface consists of:
soaking coffee beans in a water, sugar, and protease enzyme solution consistent with the mammalian digestive processes.

3. The method of claim 2 further consists of:
mixing the soaked beans with DE powder; and
drying the beans.

4. The method of claim 1 wherein bonding DE to the surface of the coffee bean consists of:
spraying the bean with DE; and,
wherein spraying is defined by a solution form.

5. The method of claim 1 wherein bonding DE to the surface of the coffee bean consists of:
spraying the bean with DE; and,
wherein spraying is defined by a dry dusting form

6. The method of preparing a beverage comprising the steps of:
grinding a batch of roasted coffee beans into grinds;
adding activated carbon to the grinds; and,
brewing the grinds with the activated carbon into coffee.

7. The method of claim 6 wherein said activated carbon is mixed with DE; and,
wherein activated carbon is in granular form.

8. A beverage filter cup comprising of:
a brewing container;
a molded plastic filter;
an upper seal; and
a lower seal.

9. The beverage filter cup of claim 8 wherein said brewing container is defined by a top lip and a bottom lip, wherein the bottom lip is configured to provide a wider and stronger surface for adherence to the lower seal.

10. The beverage filter cup of claim 9 wherein said molded plastic filter is coupled to the lip of the brewing container.

11. The beverage filter cup of claim 10 wherein said upper seal is adhered to the top lip of the brewing container.

12. The beverage filter cup of claim 11 wherein said lower seal is adhered to the bottom lip of the brewing container.

13. The beverage filter cup of claim 12 further defined by a molded plastic filter wherein the filter is porous.

14. The beverage filter cup of claim 13 further defined by a support extension chamber.

15. The beverage filter cup of claim 14 wherein said support extension chamber is permeable.

16. The beverage filter cup of claim 15 wherein said support extension chamber is defined by an inlet area.

17. The beverage filter cup of claim 16 wherein said brewing container is defined by a body that tapers downwardly.

18. The beverage filter cup of claim 17 wherein said filter cup tapers away from the sidewalls of the brewing container toward its center.

19. The beverage filter cup of claim 18 wherein said filter cup is defined by ribs along the walls of the filter cup.
